(19) United States
(12) Patent Application Publication
(10) Pub. No.: US 2011/0191551 A1
(43) Pub. Date: Aug. 4, 2011

(54) STORAGE APPARATUS AND STORAGE MANAGEMENT METHOD

(75) Inventors: Yoshinari SHINOZAKI, Kawasaki (JP); Takashi Kawada, Kawasaki (JP); Hidenori Yamada, Kawasaki (JP)

(73) Assignee: FUJITSU LIMITED, Kawasaki-shi (JP)

(21) Appl. No.: 13/014,136

(22) Filed: Jan. 26, 2011

(30) Foreign Application Priority Data
Jan. 29, 2010 (JP) 2010-017829

(51) Int. Cl. G06F 12/00

(52) U.S. Cl. 711/154; 711/E12.001

(57) ABSTRACT

A storage apparatus capable of copying data to a destination apparatus includes storages including a plurality of volumes for storing data, memories for temporarily storing data to be copied to the destination apparatus, and processors for controlling to copy the data, each processor being configured to manage the memories and parts of the volumes, respectively, and wherein one processor executes storing received write data to one memory and the part, detecting each data amounts stored in the memories when an data amount of one memory is greater than a predetermined amount, allocating management of a part of the part managed by the one processor to other processor when the amount of the data stored in the one memory is greater than an amount calculated by using the data stored in the memories, and transmitting the data stored in the memories to the destination apparatus.

### CROSS-REFERENCE TO RELATED APPLICATION

This application is based upon and claims the benefit of priority of the prior Japanese Patent Application No. 2010-017829, filed on Jan. 29, 2010 the entire contents of which are incorporated herein by reference.

### FIELD

The embodiments discussed herein are related to a technique for copying data between storage apparatuses.

### BACKGROUND

A storage system records data on a plurality of disks in order to improve the performance of data transfer or the data retention reliability thereof. Even if writing to a disk is stopped suddenly owing to, for example, a crash of an operating system (OS) of a server or the like, the storage system can, after restoration, recover data recorded on a plurality of disks before the stoppage. In order to enable the data recovery, the storage system controls the order in which data is written to a disk. In addition, the storage system may perform data mirroring between a plurality of storage apparatuses. In data mirroring, a source storage apparatus having a volume in which data to be mirrored is stored and a destination storage apparatus having a volume in which mirrored data is to be stored control the order in which data is written to a disk so as to make it possible to recover the data in a shorter period of time if an abnormal condition occurs during a process for copying the data. That is, the storage system copies data in the same order as in writing of the data. In a synchronous copying mode, in which copying is performed in synchronization with writing, a writing process and a copying process are executed in the same order in a storage apparatus. However, there may be a case in which the source storage apparatus and the destination storage apparatus are located at distant places. It is unsuitable to use the synchronous copying mode for mirroring between distant places because the mirroring is affected by delay caused in a transmission line. Therefore, when performing mirroring between distant places, the storage system uses an asynchronous copying mode, which is less affected by the effect of delay.

In the asynchronous copying mode, in which the order of reading and writing is guaranteed, data written to the source apparatus by a host apparatus is stored in a dedicated buffer (Remote Equivalent Copy (REC) buffer) in a cache of the source apparatus. The dedicated buffer is used for an asynchronous copying function that guarantees the order of reading and writing. In a storage system of a distributed cache memory type, in order to simplify the configuration, a group of redundant arrays of inexpensive disks (RAID) and a volume therein are allocated to one of the controller modules in a storage apparatus and each controller module controls a volume allocated thereto. For this reason, a dedicated buffer is provided for each control module. The area of the dedicated buffer for each controller module is divided into a plurality of generations in a chronological manner. In addition, in order to guarantee the order of reading and writing in asynchronous copying, the generations of each controller module are organized over a plurality of controller modules into a unit called a “buffer set” in advance. The storage system executes a copying process using a buffer set as a unit. When a use ratio of a portion of the dedicated buffer in the cache of the source apparatus to an entire storage area of the dedicated buffer exceeds a predetermined value (including a case in which the entire storage area is used), or when a predetermined period of time has elapsed since data storage began, the controller modules synchronize buffer data in the cache of the source apparatus in order to collectively transmit the buffer data to the destination apparatus. Upon having received all the data that was synchronized and transmitted by the controller modules, the destination apparatus collectively expands the received data in a storage medium therein.

However, since copying between storage apparatuses uses a buffer set as a unit, volumes in the source apparatus may be intensively associated with a single controller module or repeated updating of data may occur in volumes controlled by a single controller module in the source apparatus. In these cases, data to be copied is intensively stored in a REC buffer of the controller module and accordingly, even when the REC buffers of other controller modules are empty, the data is collectively transmitted in units of a generation. Since the data is transmitted in spite of no data being stored in some dedicated buffers, storage areas of the dedicated buffers are used inefficiently. Japanese Laid-open Patent Publication No. 2005-275525 is an example of the related art.

### SUMMARY

According to an aspect of the invention, a storage apparatus capable of copying data to a destination apparatus includes a plurality of storages for storing data, the plurality of storages including a plurality of volumes, a plurality of memories for temporarily storing data to be copied to the destination apparatus, and a plurality of processors for controlling to copy the data, each of the plurality of the processors being configured to manage the plurality of the memories and parts of the plurality of volumes, respectively, wherein at least one of the plurality of the processors executes receiving write data, storing the write data to one of the plurality of the memories and the part managed by the at least one of the plurality of the processors, detecting each amounts of data stored in the plurality of the memories when an amount of the data stored in one of the plurality of the memories is greater than a predetermined amount, allocating management of a part of the part managed by the at least one of the plurality of the processors to other of the plurality of the processors when the amount of the data stored in the at least one of the plurality of the memories is greater than an amount calculated by using the data stored in the plurality of the memories, and transmitting the data stored in the plurality of the memories to the destination apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a storage system according to an embodiment of the present invention;

FIG. 2 is an explanatory diagram illustrating a REC buffer controlled by each controller module of a source storage apparatus 20 according to the embodiment;

FIG. 3 illustrates a buffer index table according to the embodiment;

FIG. 4 illustrates a session control table according to the embodiment;

FIG. 5 illustrates a buffer set table according to the embodiment;

FIG. 6 is a flowchart illustrating a process for storing data in a REC buffer according to the embodiment;

FIG. 7 is a flowchart illustrating a process performed when a buffer set is switched;

FIG. 8 illustrates an example of session allocation information transmitted to a controller module CM01 according to the embodiment;

FIG. 9 illustrates an example of session allocation information transmitted to a controller module CM02 according to the embodiment;

FIG. 10 illustrates an example of session allocation information transmitted to a controller module CM03 according to the embodiment;

FIG. 11 illustrates an example of session allocation information transmitted to a controller module CM04 according to the embodiment;

FIG. 12 is a flowchart illustrating a process for allocating the number of sessions according to the embodiment;

FIG. 13 illustrates an example of the number of I/Os obtained from each controller module according to the embodiment;

FIG. 14 illustrates an example of obtained I/O ratios according to the embodiment;

FIG. 15 illustrates an example of the number of sessions for each controller module according to the embodiment;

FIG. 16 illustrates an example of a maximum number of sessions to be allocated to each controller module according to the embodiment;

FIG. 17 illustrates an example of the determined number of sessions to be distributed to each controller module according to the embodiment; and

FIG. 18 is a flowchart illustrating a process for determining a REC buffer in which data is stored according to the embodiment.

### DESCRIPTION OF EMBODIMENTS

Hereinafter, embodiments will be described in detail with reference to drawings.

Storage System

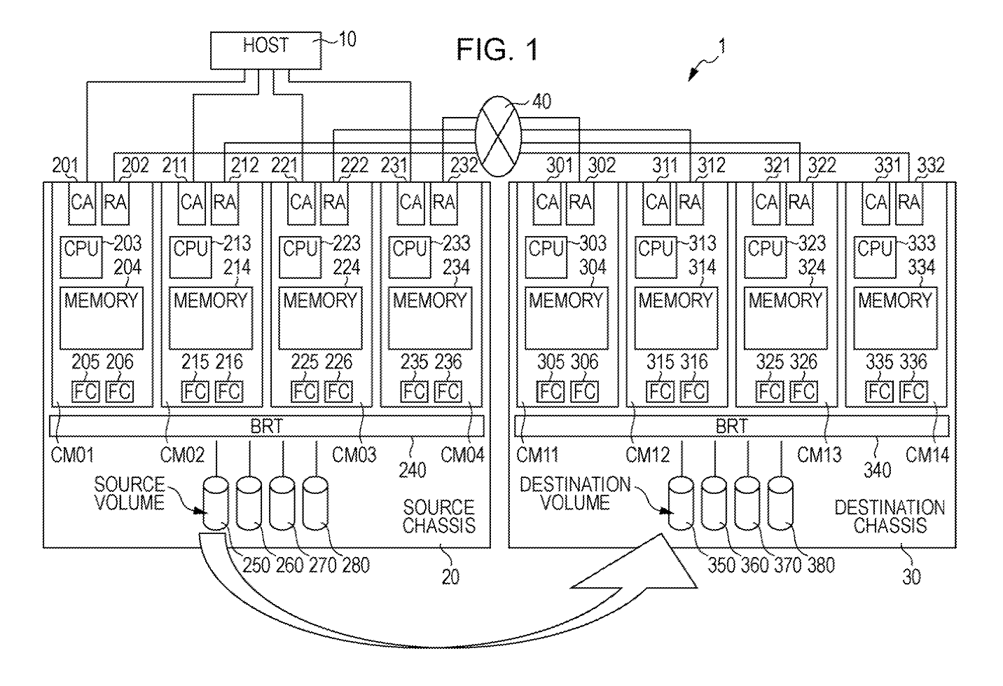

FIG. 1 illustrates a storage system according to an embodiment.

A storage system 1 includes a host apparatus 10, a storage apparatus 20, and a storage apparatus 30. In this embodiment, the host apparatus 10 is connected to the storage apparatus 20 by a network such as a storage area network (SAN), and the storage apparatus 20 is connected to the storage apparatus 30 by a network 40 such as a wide area network (WAN). The storage apparatus 20 and the storage apparatus 30 are, for example, located at places distant from each other. In this embodiment, the host apparatus 10 writes data to the storage apparatus 20 and the data in the storage apparatus 20 is copied into the storage apparatus 30. That is, the storage apparatus 20 is a source apparatus having data to be subjected to a copying process and the storage apparatus 30 is a destination apparatus in which the data is newly stored through the copying process. In the following description, data to be subjected to the copying process will also be called “copy data”.

The host apparatus 10 sends an instruction regarding reading or writing of data to the storage apparatus 20 in order to perform reading of data from or writing of data to the storage apparatus 20.

Storage Apparatuses

Next, the storage apparatus 20 and the storage apparatus 30 will be described. For convenience of description, the storage apparatus 20 and the storage apparatus 30 have the same volume configuration in this embodiment. The storage apparatus 20 will be described hereinafter and description of modules in the storage apparatus 20 having the same functions and portions of the storage apparatus 30 similar to those of the storage apparatus 20 is omitted. In addition, the storage apparatus 20, which is a source apparatus, may be simply called a “source”, and the storage apparatus 30, which is a destination apparatus, may be simply called a “destination” in the following description.

The storage apparatus 20 and the storage apparatus 30 in this embodiment are of a distributed cache memory type in which each controller module (hereinafter may be referred to as CM) has a cache memory, respectively. Therefore, a volume, which is a control unit of a disk apparatus in which data is stored, is preset to belong to any one of CMs in a storage apparatus. A volume includes a logical volume that exists logically and that is defined by a technique such as combining two or more physically independent volumes, that is, for example, by organizing storage areas of each disk apparatus, by configuring a RAID from volumes, or by combining RAIDs. The copying process from the storage apparatus 20 to the storage apparatus 30 can be performed even when the RAID configurations of the source and destination storage apparatuses are different, so long as an area for storing the data to be copied can be reserved in the destination storage apparatus 30.

The storage apparatus 20 has a plurality of controller modules CM01, CM02, CM03, and CM04. Storages 250, 260, 270, and 280 are, for example, magnetic disks that store data. A back-end router (BRT) 240 serves as a connection between disks (250, 260, 270, and 280) and the controller modules (CM01, CM02, CM03, and CM04). Each controller module can perform reading (READ) of data from and writing (WRITE) of data to each disk.

The storage apparatus 20 makes any of the CMs therein function as a master CM. In the following description, a CM that controls each CM of the storage apparatus 20 is called a “master CM” and CMs other than the master CM are simply called “CMs”. The master CM has a function of an ordinary CM as well as a function of controlling the other CMs. In this embodiment, the controller module CM01 is a master CM. Upon a generational change, the master CM obtains input/output (I/O) information of REC buffers from the controller modules CM01, CM02, CM03, and CM04 of the storage apparatus 20 with which the REC buffers are each associated, so as to execute a process for determining which volumes are to be associated with each CM in the next generation.

The controller module CM01 (CM02, CM03, or CM04) has a channel adapter (CA) 201 (211, 221, or 231), a remote adapter (RA) 202 (212, 222, or 232), a memory 204 (214, 224, or 234), a central processing unit (CPU) 203 (213, 223, or 233), and device adapters (DAs) 205 and 206 (215 and 216, 225 and 226, or 235 and 236). The CA 201 is an interface for connecting the host apparatus 10 and the storage apparatus 20. The RA 202 is an interface for connecting to an RA 302 of the storage apparatus 30. Each RA is used for, for example, transferring data during a copying process between storage apparatuses. The DAs are interfaces for connecting the BRT 240 and the CMs.

The memory 204 includes a REC buffer that is an area for storing buffer data. The memory 204 stores a buffer index table (BIT table), a buffer set control table, and a session control table. In addition, the memory includes an area for storing a control program to be operated by the CPU 203.

The CPU 203 controls the entire operation of the controller module CM01, such as disk control for controlling reading data from and writing data to a disk apparatus, CA control for controlling transmission and reception of information to/from the host apparatus 10, cache memory control for controlling the memory 204, copying process control for controlling the copying process, and a request for a copying process to another CM.

Description of controller modules CM11, CM12, CM13, and CM14, a BRT 340, disks 350, 360, 370, and 380 in the storage apparatus 30, which is the destination in this embodiment, is omitted. In addition, description of a CA 301 (311, 321, or 331), an RA 302 (312, 322, or 332), a memory 304 (314, 324, or 334), a CPU 303 (313, 323, or 333) and fibre channels (FCs) 305 and 306 (315 and 316, 325 and 326, or 335 and 336) included in the controller module CM11 (CM12, CM13, or CM14) is also omitted.

I/O data is data to be read or written that is received from the host apparatus 10. The I/O data includes main data and copying control information for controlling copying of data. The copying control information includes addresses of a source and a destination.

When the I/O data is received, the main data is stored in a REC buffer and the copying control information is stored in a BIT table.

When securing the order of a process for reading or writing data, the storage system 1 uses a REC buffer to transfer data to be copied from a disk apparatus in the source storage apparatus 20 to a disk apparatus in the destination storage apparatus 30. For example, data is copied from the source into the destination in the following steps. First, a CM of the source storage apparatus 20 that controls a volume for copying stores copy data from a disk apparatus in a REC buffer. When any of REC buffers of a generation to be processed in a buffer set is filled up, or a predetermined period of time has elapsed since the copy data was stored in the REC buffer, the source collectively transfers the copy data in the buffer set to a REC buffer in the destination storage apparatus 30. The destination storage apparatus 30 stores the received copy data in the REC buffer. The destination storage apparatus 30 stores all the copy data in a dedicated buffer and then stores all the copy data in a recording medium 12 thereof. When the expansion of the copy data has been completed, the destination storage apparatus 30 notifies the source storage apparatus 20 of the completion of the expansion. After that, the source storage apparatus 20 releases the copy data in the REC buffer.

Next, information included in a REC buffer, a BIT table, a buffer set control table, and the like that are stored in a memory will be described.

REC Buffer

First, a REC buffer (dedicated buffer) is described. A REC buffer is included in each CM and is used as a storage area for storing information necessary for a copying process during a copying process executed between storage apparatuses (Remote Equivalent Copy (REC)). In this embodiment, main data to be copied is stored in REC buffers.

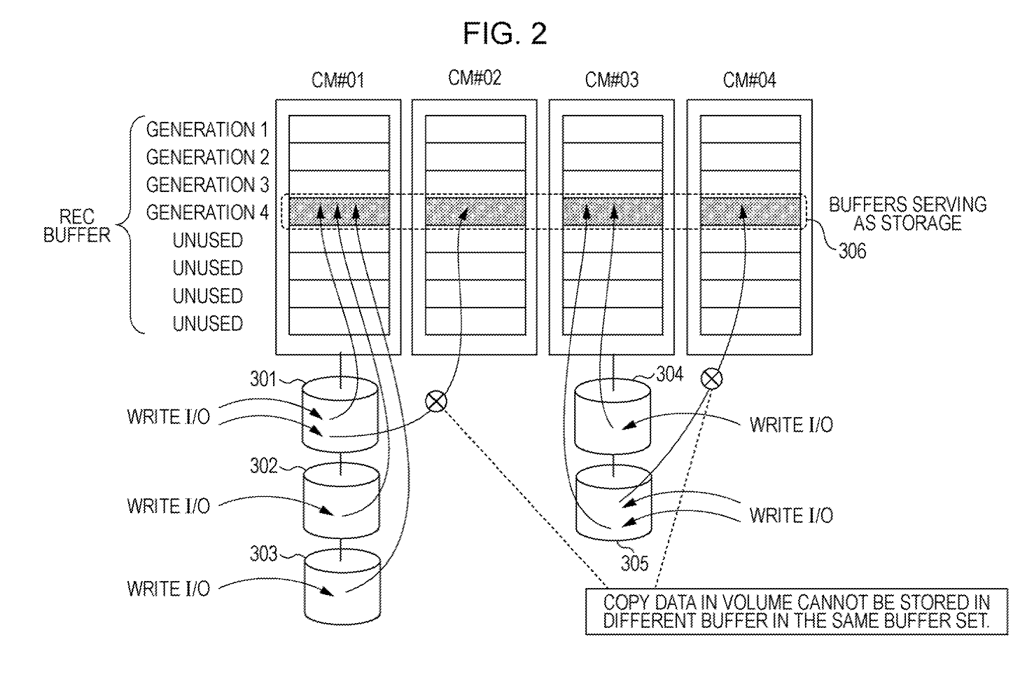

FIG. 2 is an explanatory diagram illustrating REC buffers controlled by the CMs of the source storage apparatus 20. A REC buffer area CM#01 of the controller module CM01, a REC buffer area CM#02 of the controller module CM02, a REC buffer area CM#03 of the controller module CM03, and a REC buffer area CM#04 of the controller module CM04 are illustrated. Each CM controls the corresponding REC buffer by dividing the REC buffer into a plurality of areas in order to guarantee the order of processes for reading and writing data. Each divided area is controlled as a generation. In FIG. 2, each REC buffer is divided into eight generations in total, namely a generation 1, generation 2, generation 3, generation 4, and four other unused generations. Each generation is controlled in a chronological manner. The REC buffer of each CM is divided into the same number of areas. Each generation is released after completion of the copying process between storage apparatuses. “Released” refers to a condition in which data can be stored in a generation. A generation is further divided into a plurality of fixed-length buffers. A CM stores data by, for example, appropriately dividing the data so that the divided pieces of data can be stored in the fixed-length buffers.

CMs to which volumes 301, 302, 303, 304, and 305 belong are defined in advance. During the copying process between storage apparatuses, each CM in the source reads data in an associated volume to the REC buffer thereof.

For example, in FIG. 2, the volumes 301, 302, and 303 belong to the controller module CM01. Therefore, upon receiving a write instruction (write I/O) for any of the volumes 301, 302, and 303 from the host apparatus 10 between storage apparatuses, the controller module CM01 stores data corresponding to the write instruction in a buffer area currently serving as a storage in a REC buffer corresponding to the write instruction.

In addition, suppose that, for example, the host apparatus 10 does not issue a write instruction to any volume, which is not illustrated, other than the volumes 301, 302, 303, 304, and 305 in FIG. 2. In this case, when a process that will be described later is not applied, the controller modules CM02 and CM04 do not store data in the REC buffers controlled thereby. Each CM controls the corresponding REC buffer.

In order to collectively control the REC buffers of the respective CMs, copying between storage apparatuses is executed using a buffer set 306 as a unit. In FIG. 2, a set of buffers surrounded by a broken line is a buffer set. The buffer set 306 is a group of data that is organized by generations, which have been obtained by chronologically dividing the REC buffer of each CM, of a plurality of CMs. By executing the copying process using a buffer set as a unit, the order of data writing can be maintained in the REC buffers that are included in the buffer set and are associated with a plurality of CMs.

In FIG. 2, a generation of the controller modules CM02 and CM04 that belongs to the buffer set 306 is used as a buffer set in spite of no data being stored therein. On the other hand, since the controller module CM01 is associated with the volumes 301, 302, and 303 that have received the write instruction, there is a lot of data to be stored in the REC buffer thereof. For this reason, an area of the generation of the REC buffer of the controller module CM01 is liable to be full. When any of the REC buffers included in a buffer set becomes full, the storage apparatus 20 switches the generation of the REC buffers that serves as a storage so as to store data in the next generation. In FIG. 2, when a REC buffer of the generation 4 that is currently being used becomes full, the storage apparatus 20 creates a generation 5 from the unused generations of the REC buffers. The storage apparatus 20 also specifies the buffer set of the generation 4 as a target of transfer to the storage apparatus 30.

BIT Table

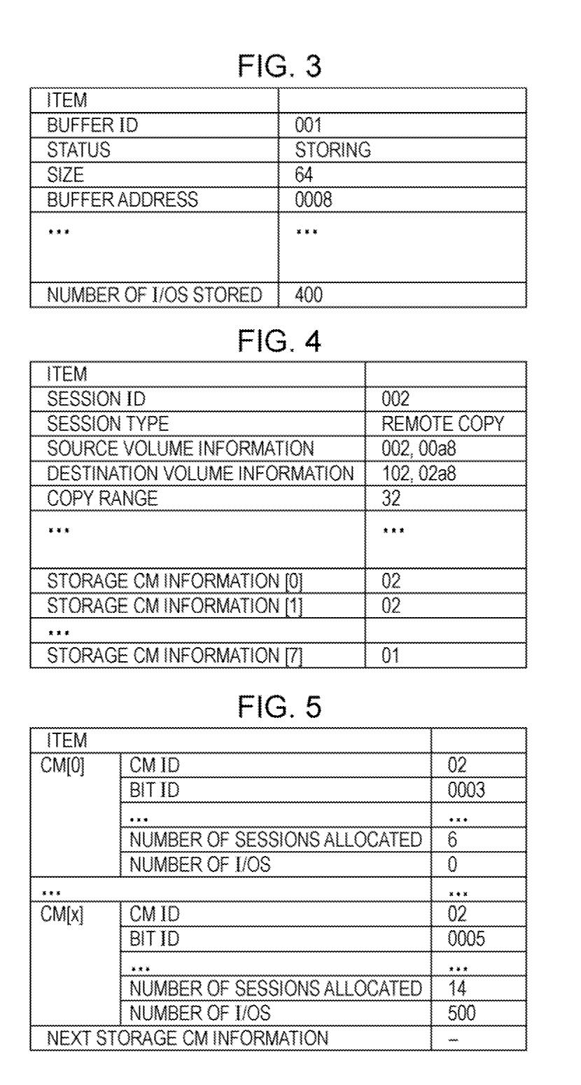

Next, a BIT table is described. FIG. 3 illustrates a BIT table. Each CM has a BIT table. The BIT tables store information for copying data stored in an individual buffer in a generation of each CM from a source to a destination. The information in a BIT table can be identified with a CM ID and a BIT ID stored in a buffer set table.

During the copying between storage apparatuses, the source transmits copy data from a REC buffer and information from a BIT table to the destination. As a result, the destination can store the copy data in the REC buffer in an appropriate area.

A BIT table includes a buffer ID, status, size, buffer address, and the number of I/Os stored. The buffer ID is identification information for identifying a buffer to be controlled. The status is information for identifying the condition of the buffer, such as storing, segmenting, segmentation complete, or transferring. The size is information for identifying the size of the buffer. The buffer address is information for identifying an actual address of data contained in the buffer, such as volume identifiers of the source and the destination and a logical block address in a volume.

The number of I/Os stored is information indicating the number of pieces of write I/O data that have been copied to a generation that is currently being processed in the REC buffers. The initial value of the number of I/Os stored is 0. When the generation of the buffer set is switched, each CM transmits the number of I/Os stored corresponding to the switched buffer to the master CM.

Session Control Table

A session control table that controls REC sessions is described here. A session is information in which the source and the destination are related. FIG. 4 illustrates a session control table. Each CM stores a session control table. For example, an administrator sets a combination between volumes in the source and the destination before starting copying. Each CM retains information of a combination in the memory thereof as a session control table.

The session control table contains information regarding a copying session and therefore exists for each session. The information regarding a copying session includes a session ID, session type, source volume, destination volume, copying range, and storage CM. The session ID is unique identification information that exists for each session. The session type is information indicating a copying type such as remote copying or local copying. The source volume is information including a volume number of the source and an initial logical block address (LBA) of the source. The destination volume is information including a volume number of the destination and an initial logical block address of the destination. The copying range is information indicating the range of the copying process. For example, the range of the copying process is indicated by the number of blocks.

The storage CM is information for identifying a CM that controls a REC buffer in which a session is to be stored. Since a REC buffer is divided into a plurality of generations and controlled, the storage CM has the number of members corresponding to the number into which the REC buffer is divided. In this embodiment, each REC buffer is divided into eight, and accordingly the storage CM in the session control table includes eight members. Upon a generational change, each CM initializes each member. When a generation receives a write I/O of copy data regarding a session whose storage REC buffer has not been determined, each CM determines the storage REC buffer and specifies a CM that controls the determined REC buffer as the storage CM. The storage CM includes “Storage CM Information [0]” that indicates a storage CM associated with a first area of the REC buffer that has been divided into eight and “Storage CM Information [1]” that indicates a storage CM associated with a second area of the REC buffer that has been divided into eight. The storage CM also includes “Storage CM Information [2]” to “Storage CM Information [7]” that indicate associated storage CMs in the same manner as above.

Buffer Set Table

Next, a buffer set table controlled by the master CM is described. FIG. 5 illustrates a buffer set table. A buffer set table controls a buffer set and more particularly controls a combination of REC buffer between the source and the destination. A buffer set is a group of the REC buffers of CMs and includes all the REC buffers that form the buffer set.

Since each REC buffer is divided into eight generations in this embodiment, each CM has eight buffer set tables corresponding to the number of generations. The generations of a buffer set are controlled in a chronological manner.

A buffer set table contains a CM ID, a BIT ID, the number of sessions allocated, information of the number of I/Os, and next storage CM information for each CM included in a buffer set.

The CM ID is information for identifying a CM that controls a buffer. The BIT ID is information for identifying a buffer.

The number of sessions allocated is set for a CM when a buffer set is newly created. Upon the initial write I/O process in a generation, each CM refers to this member (also to those of the other CMs) and “Next Storage CM Information” to determine a REC buffer for storing data. The number of I/Os indicates the number of I/Os stored in a buffer of the previous generation about which notification is performed by each CM upon switching of a buffer set. The next storage CM information is information for determining a REC buffer that serves to store a session of a CM in the initial write I/O in a generation. At the time when the master CM creates a buffer set table related to a new generation, an initial value (invalid value) is set to the buffer set table as the number of sessions allocated. The number of sessions allocated is updated when the initial write I/O in a generation is processed in a session of a CM.

Next, the copying process between storage apparatuses is described.

Process for Storing Data in REC Buffer

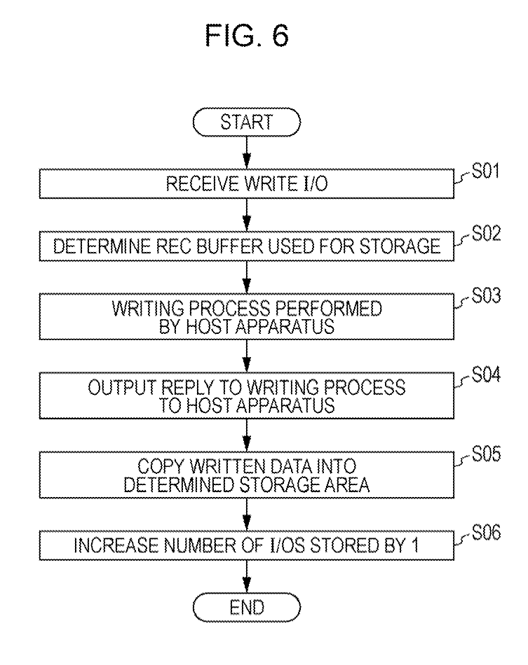

First, a process for storing data in a REC buffer is described in accordance with a flowchart of FIG. 6 illustrating the process for storing data in the REC buffer. Any of the controller modules CM01 to CM04 performs the process for storing data in the REC buffer thereof.

A CM receives a write instruction (write I/O) from the host apparatus 10 (S01). The write I/O contains information such as address information of a volume to which data will be written, size information of the write data, and main data.

The CM determines a REC buffer for storing the write I/O (S02). A process for determining the REC buffer in S02 will be described in detail later.

After the REC buffer for storing the write I/O is determined, the main data is written to a disk apparatus corresponding to the address information of the volume identified with the write I/O received in S01 (S03). The main data may be written to a cache memory for temporarily storing data, instead of the disk apparatus.

After the main data has been written in S03, the CM outputs a reply to the write instruction to the host apparatus 10 (S04). The data written in the writing process is then stored in the REC buffer determined in S02 (S05). The processes in S04 and S05 do not need to be synchronized.

After the process for storing data to the REC buffer in S05, the CM that controls the REC buffer to which the data has been written increments the number of I/Os in the BIT table by 1 (S06). In addition, the CM that controls the REC buffer to which the data has been written writes the buffer ID, status, size, buffer address, and the number of I/Os stored to the BIT table.

Commission of Storing Data to Another CM

The data expansion in S05 is described here. In this embodiment, each CM may store not only data in the REC buffer controlled thereby, but also data in a REC buffer controlled by another CM.

An example of a process that is performed when a CM stores copy data in a REC buffer controlled by another CM is described here. First, a CM queries another CM (a CM that controls a REC buffer in which data will be stored) as to whether the another CM can reserve an area large enough to store copy data. The CM executes the query by, for example, transmitting the size of the copy data to the other CM. The other CM reserves an area having the size notified through the query. The other CM then replies by notifying the querying CM of an area corresponding to the size having been reserved in the REC buffer. The CM transmits the copy data to the other CM. The other CM stores the copy data received from the CM in the REC buffer thereof.

When a CM stores data input to a volume associated therewith in a REC buffer thereof, the CM secures an area of the REC buffer and stores the data in the area. Thus, a process for storing data in its own REC buffer of a CM is simpler than a process for storing copy data input to a volume associated with a CM in a REC buffer of another CM.

Buffer Set Switching Process

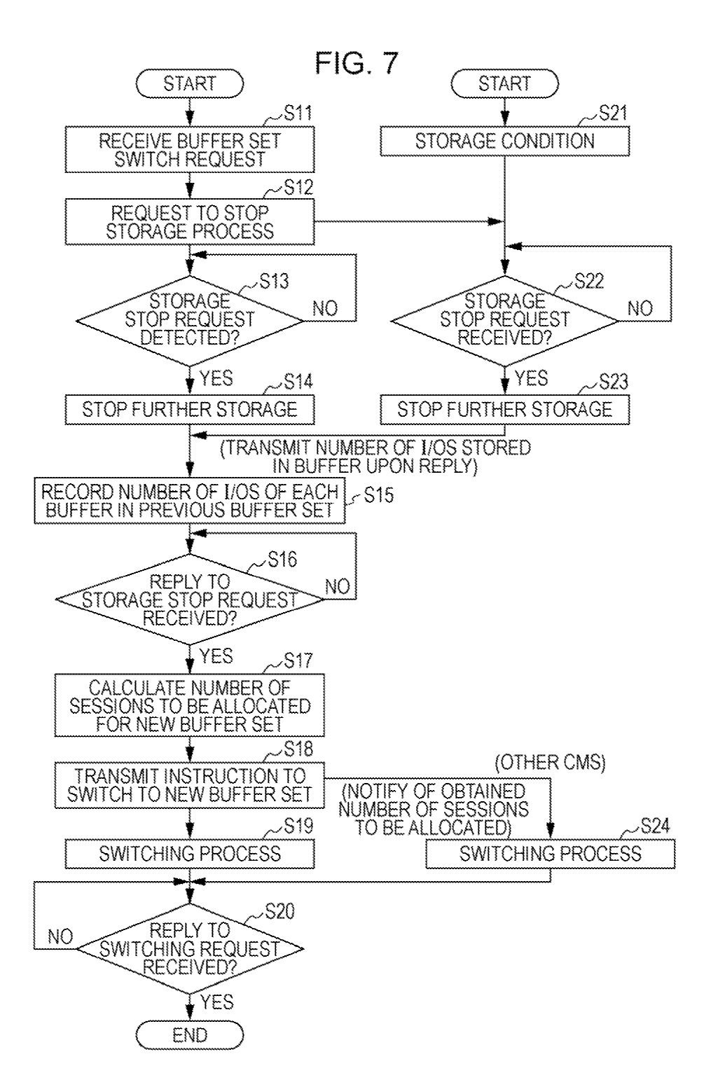

Next, a process for switching a buffer set is described in accordance with a flowchart of FIG. 7 illustrating the process for switching a buffer set. When a buffer set is switched, transmission and reception of information between the master CM (CM01) and the other CMs (CM02, CM03, and CM04) occur. The master CM determines the number of sessions associated with each CM in the next generation upon the switching of the buffer set.

In this embodiment, sessions associated with each CM are changed upon a generational change. When individual pieces of copy data that belong to a single session are stored in a plurality of REC buffers while the same generation continues, each CM in the destination needs to perform a process for determining the order of I/Os between the REC buffers, which is inefficient.

The master CM receives a request to switch the generation of the buffer set (S11). The generation of a buffer set is switched when a predetermined period of time has elapsed since the process of the current generation began, or when the storage area of the current generation in the REC buffer of any of the controller modules CM01 to CM04 is filled up with copy data. In this embodiment, a request to switch the generation of the buffer set may be received upon detection of a predetermined period of time having elapsed since the current generation began, or upon notification that the storage area of the current generation in the REC buffer of any of the controller modules CM01 to CM04 is filled up with copy data.

When receiving a request to switch the generation in S11, the master CM requests each CM (CM01, CM02, CM03, or CM04) to stop the process for storing data in the corresponding REC buffer (S12). At this time, the master CM transmits an instruction to stop the process for storing copy data in the REC buffers to all the CMs that form the buffer set.

Operation of the other CMs is described here. Before the master CM executes a process for switching the buffer set, each CM (CM01, CM02, CM03, or CM04) is in a condition in which the process for storing data in the corresponding REC buffer can be performed. The other CMs (CM02, CM03, and CM04) execute data storage in the REC buffers in accordance with a write I/O from the host apparatus 10 (S21). In S12, the master CM requests each CM (CM01, CM02, CM03, or CM04) to stop the storing process. At this time, each CM obtains the request to stop the storage process from the master CM.

Each CM determines whether or not a request to stop the storage has been detected (S22). If a request to stop the storage has not been detected (S22: NO), each CM continues to execute the storage process. If a request to stop the storage has been detected (S22: YES), each CM stops further storage of data in the current generation (S23). After stopping the storage process of S23, each CM transmits a reply to the request to stop the storage and the number of I/Os of data stored in the REC buffer of the current generation, which has served as a storage of each CM, to the master CM by reading the number of I/Os from the BIT table.

On the other hand, the master CM executes processes of S13 and S14 as the controller module CM01 in a similar manner as the other CMs (CM02, CM03, and CM04). The master CM (CM01) determines whether or not a request to stop the storage has been detected (S13). If a request to stop the storage has not been detected (S13: NO), the master CM continues to wait for a request to stop the storage to be obtained. If a request to stop the storage has been detected (S13: YES), the master CM (CM01) stops further storage of data in the current generation (S14).

The master CM records the number of I/Os of the previous generation served as a storage that is obtained from each CM on the buffer set table of the new generation as the number of I/Os of each CM (S15). The master CM then determines whether or not a reply to the request to stop the storage has been obtained from each CM (S16). If a reply to the request to stop the storage has not been obtained from each CM (S16: NO), the master CM waits for a reply from each CM. On the other hand, if a reply to the request to stop the storage has been obtained from each CM (S16: YES), the master CM calculates the number of sessions to be allocated to each CM for a buffer set of the new generation (new buffer set) (S17). A process for allocating the number of sessions will be described later.

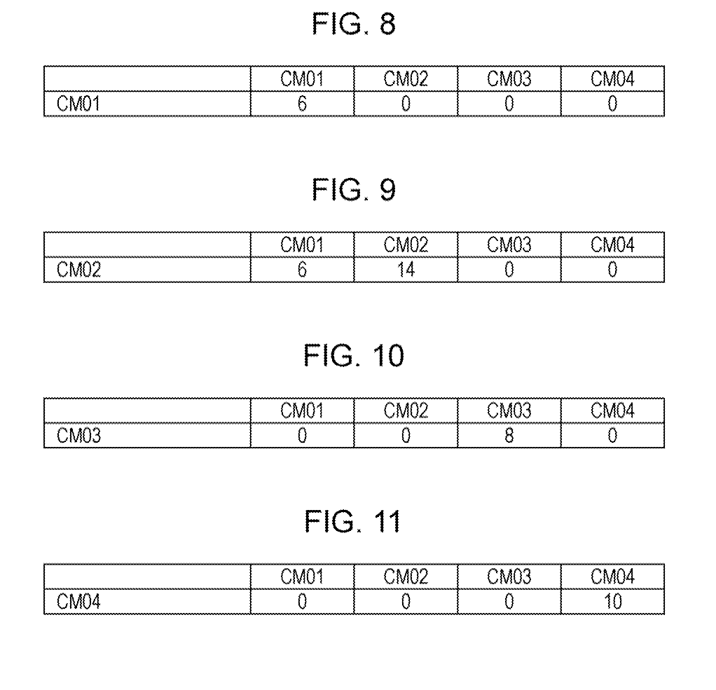

The master CM transmits an instruction to switch to the new buffer set to each CM (S18). Along with the switching instruction of S18, the master CM also transmits the buffer set table including updated session allocation information to each CM. FIGS. 8 to 11 illustrate examples of the session allocation information transmitted to the controller modules CM01 to CM04, respectively. FIG. 9 illustrates that the number of sessions that the controller module CM02 stores in the REC buffer of the controller module CM01 is 6 and the number of sessions that the controller module CM02 stores in the REC buffer of the controller module CM02 itself is 14.

Operation of the other CMs is described here. In S18, the master CM transmits the instruction to switch to the new buffer set to each CM. At this time, each CM executes a process for switching the generation in accordance with the received switching instruction (S24). Each CM stores the session allocation information transmitted from the master CM. On the other hand, the master CM executes a process for switching the generation as the controller module CM01 in a similar manner as the other CMs (CM02, CM03, and CM04) (S19). The master CM (CM01) stores the session allocation information. Each CM transmits a reply to the request to switch the generation to the master CM.

The master CM determines whether or not a reply to the request to switch the generation has been obtained from each CM (S20). If a reply to the request to switch the generation has not been obtained from each CM (S20: NO), the master CM waits for a reply from each CM. If a reply to the request to switch the generation has been obtained from each CM (S20: YES), the master CM terminates the switching process. Each CM restarts a process for storing copy data in areas of a new generation.

Process for Allocating Number of Sessions

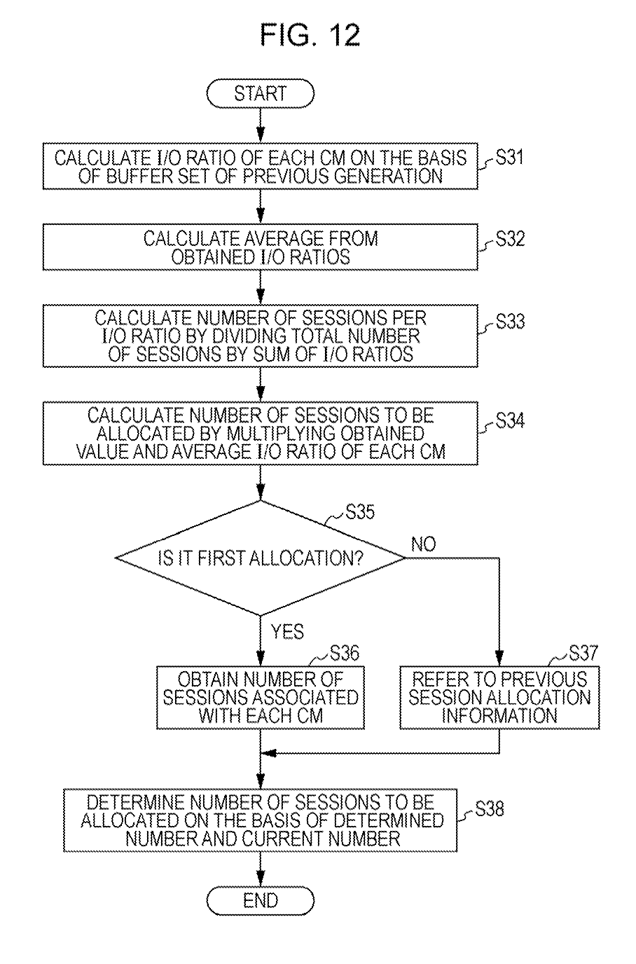

Next, a process of S17 for allocating the number of sessions to the REC buffer of each CM in the new buffer set is described in accordance with a flowchart of FIG. 12 illustrating the process for allocating the number of sessions. In this embodiment, allocation of the number of sessions to CMs is determined in units of sessions. How the number of sessions are to be allocated in the new buffer set is determined on the basis of the situation of data storage in the previous buffer set that has served as a storage (the buffer set of the previous generation). The master CM determines how the number of sessions are to be allocated on the basis of the number of I/Os obtained from each CM.

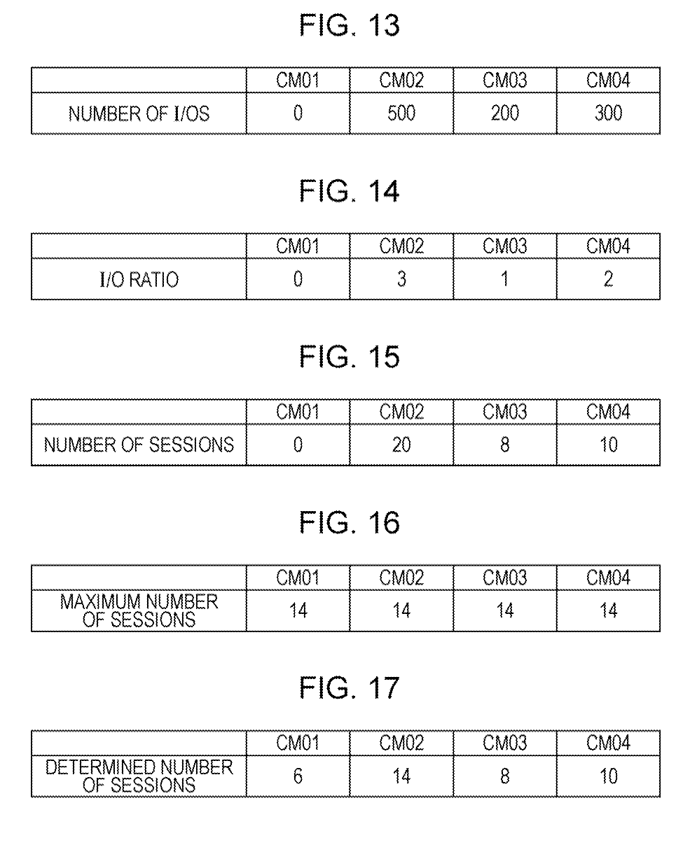

The reason why the number of sessions to be allocated is determined on the basis of the number of I/Os is that it is possible to suppose that the number of I/Os and the number of sessions are in proportion to each other. In addition, since the allocation of the number of sessions is performed upon a generational change, it is possible to distribute volumes associated with each controller module in accordance with the situation of data storage in the previous REC buffers. The master CM calculates the ratio of I/Os of each CM on the basis of the buffer set of the previous generation (S31). FIG. 13 illustrates the number of I/Os obtained from each CM. In FIG. 13, the number of I/Os of the controller module CM01 is 0, the number of I/Os of the controller module CM02 is 500, the number of I/Os of the controller module CM03 is 200, and the number of I/Os of the controller module CM04 is 300. The master CM detects, for example, the smallest number of I/Os from among the numbers of I/Os more than 0. The controller module CM03 having a number of I/Os of 200 is the one in the case of FIG. 13. The master CM calculates an I/O ratio by dividing the number of I/Os of each another CM by the detected number of I/Os. Decimals are rounded up here. FIG. 14 illustrates the obtained I/O ratios.

The master CM calculates the sum of the I/O ratio of each CM obtained in S31 and divides the sum by the number of CMs included in the buffer set in order to obtain the average number of I/Os per CM (S32). For example, the sum of the I/O ratio of each CM illustrated in FIG. 14 is obtained by an expression 0+3+1+2=6. The master CM divides the obtained sum by the number of CMs included in the buffer set, which is 4. Decimals are rounded up here. As a result, an average number of the I/O ratios of 2 is obtained.

Next, the master CM divides the total number of sessions by the sum of the I/O ratios in order to obtain the number of sessions per I/O ratio (S33). The master CM obtains the number of sessions of each CM from the session control tables. FIG. 15 illustrates an example of the number of sessions of each CM. The sum of the number of sessions of each CM illustrated in FIG. 15 is obtained by an expression 0+20+8+10=38. The master CM divides the sum of the number of sessions of 38 by the sum of the I/O ratios of 6 in order to obtain the number of sessions per I/O ratio, which is 7.

The master CM multiplies the number of sessions per I/O ratio obtained in S33 and the average number of the I/O ratio of each CM obtained in S32 in order to obtain the number of sessions to be allocated to each CM (S34). FIG. 16 illustrates a maximum number of sessions to be allocated to each CM.

Next, the master CM determines whether or not the process for allocating the number of sessions is being performed for the first time (S35). If the process for allocating the number of sessions is being performed for the first time (S35: YES), the master CM uses the number of sessions associated with each CM as the session allocation information (S36). If the process for allocating the number of sessions is being performed for the second time or more (S35: NO), the master CM uses the session allocation information that was used in the previous generation (S37).

The master CM then determines the number of sessions to be allocated to each REC buffer of the new generation on the basis of the average number of the sessions to be allocated to each CM determined in S34 and the session allocation information of the previous generation determined in S35 to S37 (S38). An example is described hereinafter. For example, the average number of sessions to be allocated to each CM is 14. If the process for allocating the number of sessions is being performed for the first time, the master CM uses the number of sessions associated with each CM illustrated in FIG. 15 as the session allocation information. The master CM distributes the number of sessions to each CM in such a manner that the maximum number of sessions to be allocated, which is 14, is not exceeded. According to the number of sessions associated with each CM illustrated in FIG. 15, the number of sessions of the controller module CM02 is 20, which is larger than the average number of 14. Therefore, the master CM restricts the number of sessions associated with the controller module CM02 so that the number of sessions does not exceed 14. As a result of the restriction, there are 6 sessions left. The master CM distributes these sessions to a controller module to which the smallest number of sessions has been distributed. The distribution of the number of sessions has thus been completed. FIG. 17 illustrates the determined number of sessions to be distributed. The master CM determines the number of sessions to be allocated to each CM of the next generation in the above-described manner. After the determination, the master CM executes the process of S18 and the subsequent processes.

Process for Determining Storage REC Buffer Executed by Each CM

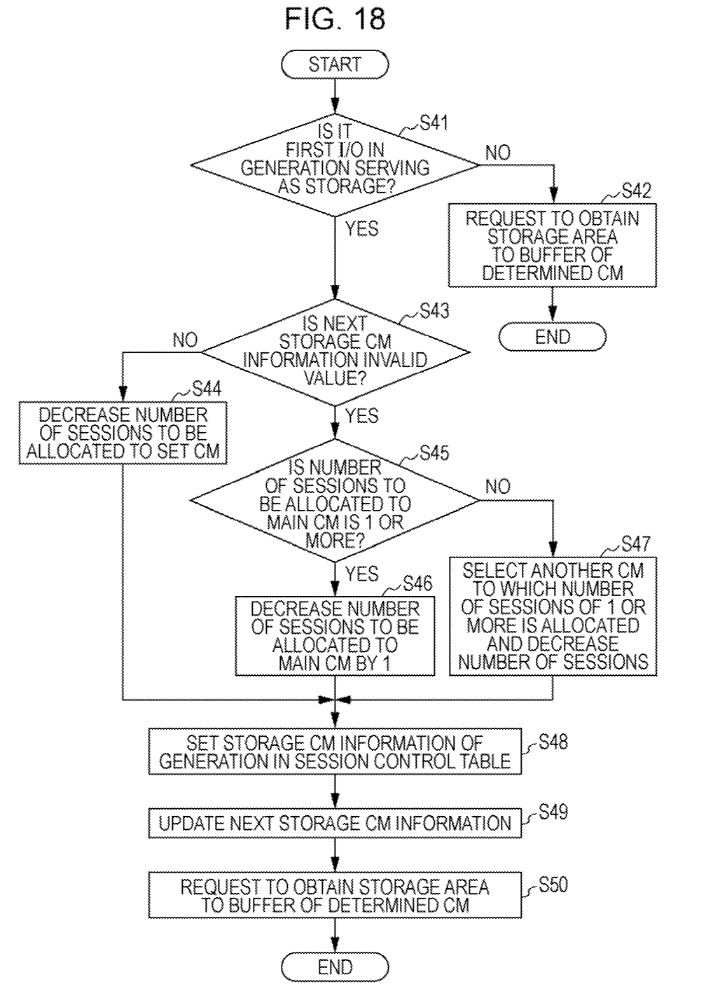

Next, a process for determining a storage REC buffer that is executed by each CM is described in accordance with a flowchart of FIG. 18 illustrating the process for determining the storage REC buffer.

The process for determining the storage REC buffer is executed by each CM (CM01, CM02, CM03, and CM04) of the storage apparatus.

Each CM has a session control table. Each CM initializes storage CM information in the session control table before S41 is performed after a generational change.

Each CM also has a buffer set table. Each CM initializes next storage CM information in the buffer set table before S43 is performed after a generational change.

Any CM (CM01, CM02, CM03, or CM04) in the source receives a write I/O transmitted from the host apparatus 10 to volumes associated therewith. A CM that has received a write I/O is called a “main CM” hereinafter.

The main CM determines whether or not the received I/O is the initial I/O in a generation that is currently serving a storage process on the basis of the storage CM information in the session control table corresponding to the generation that is currently serving a storage process (S41). If the storage CM information has been set, that is, if the received I/O is not the initial I/O (S41: NO), the main CM transmits a request to obtain a storage area to the REC buffer of a CM for which it has already been determined which REC buffer the sessions are to be stored in (S42). If the storage CM information has not been set, that is, the received I/O is the initial I/O (S41: YES), the main CM determines whether or not the next storage CM information in the buffer set table is invalid (whether or not the next storage CM information has been set) (S43).

If the next storage CM information has been set, that is, if it is determined in S43 that the next storage CM information is not invalid (S43: NO), the main CM decreases the number of sessions to be allocated to a storage CM whose buffer set table has been set (S44). After that, the main CM executes a process of S48. On the other hand, if the next storage CM information in the buffer set table has not been set, that is, if it is determined in S43 that the next storage CM information is invalid (S43: YES), since it is a session using a combination between a source volume and a destination volume that has not been previously used in the generation, it is determined whether or not the number of sessions to be allocated to the main CM is 1 or more by checking a buffer set table of the generation that is serving as a storage for the number of sessions to be allocated to each CM (S45). If it is determined in S45 that the number of sessions to be allocated to the main CM is 1 or more (S45: YES), the number of sessions to be allocated to the main CM is decreased by 1 (S46). On the other hand, if it is determined in S45 that the number of sessions to be allocated to the main CM is less than 1 (S45: NO), another CM to which the number of sessions of 1 or more is allocated is selected and the number of sessions to be allocated to the selected CM is decreased by 1 (S47). In a process according to this embodiment, the number of sessions to be allocated to the main CM is preferentially used. It is also possible to alternately distribute the number of sessions to the main CM and the other CMs.

After determining how to allocate the number of sessions, the main CM sets the storage CM information of the generation determined in S44, S46, or S47 as the storage CM information of the corresponding sessions in the session control table (S48).

The main CM updates the next storage CM information in the buffer set table of the generation that is serving as a storage (S49). For example, the main CM searches for a CM to which a number of sessions of 1 or more has been allocated from among CMs other than the one set in S48, and sets the found CM as the next storage CM information. In addition, when the number of sessions to be allocated to the main CM and those to other CMs are all 0, the main CM sets itself as the next storage CM information. The main CM then transmits a request to obtain a storage area to the REC buffer of the determined CM (S50).

Release of Generation

The source prevents exhaustion of a buffer area by changing the generation of the buffer set that has completed copying to an unused buffer. When a process for storing data contained in a generation of a buffer set that is subjected to the processing in a disk apparatus has been completed, the master CM in the destination transmits information regarding the completion of the copying in the generation to the source. Upon receiving the information regarding the completion of the copying from the destination, the master CM in the source changes the generation corresponding to the notification of the completion to an unused generation.

A storage apparatus according to this embodiment can be applied to a storage system that stores data. The storage apparatus changes volumes associated with each controller module in such a way as to reduce bias in the amount of use of buffers used for copying between storages apparatuses and, accordingly, makes it possible to use the buffer of each controller module with less loss. As a result, the storage apparatus disclosed herein can efficiently execute a copying process.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage apparatus capable of copying data to a destination apparatus, comprising:
a plurality of storages for storing data, the plurality of storages including a plurality of volumes;
a plurality of memories for temporarily storing data to be copied to the destination apparatus; and
a plurality of processors for controlling to copy the data, each of the plurality of the processors being configured to manage the plurality of the memories and parts of the plurality of volumes, respectively,
wherein at least one of the plurality of the processors executes:
receiving write data,
storing the write data to one of the plurality of the memories and the part managed by the at least one of the plurality of the processors,
detecting each amounts of data stored in the plurality of the memories when an amount of the data stored in one of the plurality of the memories is greater than a predetermined amount,
allocating management of a part of the part managed by the at least one of the plurality of the processors to other of the plurality of the processors when the amount of the data stored in the at least one of the plurality of the memories is greater than an amount calculated by using the data stored in the plurality of the memories, and
transmitting the data stored in the plurality of the memories to the destination apparatus.

2. The storage apparatus according to claim 1, wherein at least one of the plurality of the processors detects the amount on the basis of the number of pieces of write Input/Output that is a request for writing write data to at least one of the plurality of the memories and the part managed by the at least one of the plurality of the processors.

3. The storage apparatus according to claim 1, wherein the calculated amount is calculated by averaging the amount of the data stored in the plurality of the memories.

4. The storage apparatus according to claim 1, wherein one of the plurality of the memories includes a plurality of areas, wherein the data stored in one of the plurality of areas of each the one of the plurality of the memories are simultaneously transmitted to the destination apparatus.

5. The storage apparatus according to claim 4, wherein the at least one of the plurality of the processors transmits the write data to be stored in the part of the part to other of the plurality of the memories managed by other of the plurality of the processors upon determining to transfer management of the part of the part to the other of the plurality of the processors.

6. A method executed by a storage apparatus capable of copying data to a destination apparatus, the storage apparatus including a plurality of processors, the method comprising:
receiving, by the storage apparatus, write data;
storing the write data to one of a plurality of memories and a part of a plurality of volumes included in a plurality of storages for storing data, the plurality of memories temporarily storing data to be copied to the destination apparatus, each of a plurality of memories and each of the parts being controlled by each of the plurality of the processors for controlling to copy the data;
detecting each amounts of data stored in the plurality of the memories when an amount of the data stored in one of the plurality of the memories is greater than a predetermined amount;
allocating management of a part of the part managed by the one of the plurality of the processors to other of the plurality of the processors when the amount of the data stored in the one of the plurality of the memories is greater than an amount calculated by using the data stored in the plurality of the memories; and
transmitting the data stored in the plurality of the memories to the destination apparatus.

7. The method according to claim 6, wherein at least one of the plurality of the processors detects the amount on the basis of the number of pieces of write Input/Output that is a request for writing write data to at least one of the plurality of the memories and the part managed by the at least one of the plurality of the processors.

8. The method according to claim 6, wherein the calculated amount is calculated by averaging the amount of the data stored in the plurality of the memories.

9. The method according to claim 6, wherein one of the plurality of the memories includes a plurality of areas, wherein the data stored in one of the plurality of areas of each the one of the plurality of the memories are simultaneously transmitted to the destination apparatus.

10. The method according to claim 9, further comprising transmitting the write data to be stored in the part of the part to other of the plurality of the memories managed by other of the plurality of the processors upon determining to transfer management of the part of the part to the other of the plurality of the processors.

11. A non-transitory computer readable storage medium with a program stored thereon, wherein the program causes a storage apparatus including a plurality of processors to execute:
receiving write data;
storing the write data to a memory and a part, the memory for temporarily storing data to be copied to the destination apparatus, the part being included in a plurality of volumes included in a plurality of storages for storing data, the memory and the part being controlled by one of the plurality of the processors for controlling to copy the data;
detecting amounts of data stored in a plurality of the memories when an amount of the data stored in one of the plurality of the memories is greater than a predetermined amount, each of the plurality of the memories being managed by the plurality of processors respectively, each of the plurality of the memories for temporarily storing data to be copied to the destination apparatus;
allocating management of a part of the part managed by one of the plurality of the processors to other of the plurality of the processors when an amount of the data stored in the at least one of the plurality of the memories is greater than an amount of the data stored in the plurality of the memories, and
transmitting the data stored in the plurality of the memories to the destination apparatus.

12. The non-transitory computer readable storage medium according to claim 11, wherein the program causes the storage apparatus to execute detecting the amount on the basis of the number of pieces of write Input/Output that is a request for writing write data to at least one of the plurality of the memories and the part managed by the at least one of the plurality of the processors.

13. The non-transitory computer readable storage medium according to claim 11, wherein the calculated amount is calculated by averaging the amount of the data stored in the plurality of the memories.

14. The non-transitory computer readable storage medium according to claim 11, wherein one of the plurality of the memories includes a plurality of areas, wherein the data stored in one of the plurality of areas of each the one of the plurality of the memories are simultaneously transmitted to the destination apparatus.

15. The non-transitory computer readable storage medium according to claim 14, wherein the at least one of the plurality of the processors transmits the write data to be stored in the part of the part to other of the plurality of the memories managed by other of the plurality of the processors upon determining to transfer management of the part of the part to the other of the plurality of the processors.
